(19) United States
(12) Patent Application Publication
(10) Pub. No.: US 2015/0147436 A1
(43) Pub. Date: May 28, 2015

(54) PRODUCTION OF CHEESE WITH S. THERMOPHILUS

(71) Applicant: DuPont Nutrition BioSciences ApS, Copenhagen (DK)

(72) Inventor: Lars W. Petersen, Muskego, WI (US)

(21) Appl. No.: 14/593,095

(22) Filed: Jan. 9, 2015

Related U.S. Application Data
(63) Continuation of application No. 14/112,892, filed on Jan. 7, 2014, now abandoned.
(60) Provisional application No. 61/477,211, filed on Apr. 20, 2011.

(51) Int. Cl. A23C 19/076; C12R 1/46; A23C 19/032

(52) U.S. Cl. CPC A23C 19/076; A23C 19/032; C12R 1/46
USPC 426/36; 426/582; 435/253.4

(57) ABSTRACT

The present invention provides methods, compositions, and systems for producing cheese with S. thermophilus and a urease inhibitor, and for producing cottage cheese with S. thermophilus that is partially or completely deficient in its ability to release ammonia from urea. The present invention also provides methods, compositions, and systems for reducing the amount of open texture (e.g., slits, cracks, or fractures) in gassy cheeses, such as cheddar cheese.

### FIELD

In one aspect, methods, compositions, and systems for producing cheese with S. thermophilus and a urease inhibitor, and for producing cottage cheese with S. thermophilus that is partially or completely deficient in its ability to release ammonia from urea are provided. Methods, compositions, and systems for reducing the amount of open texture (e.g., slits, cracks, or fractures) in gassy cheeses, such as, for example, cheddar cheese are also provided.

### BACKGROUND

Streptococcus thermophilus is a thermophilic lactic bacterium used as a lactic ferment in the dairy industry. First used for the manufacture of fermented milks such as yoghurt, it is now increasingly used in cheese production, for example, in production of cheeses that was formerly made with Lactococci bacteria, such a Lactococcus lactis or Lactococcus cremoris.

This bacterium converts lactose in milk into lactic acid, which acidifies the milk. In the case of cheeses, this acidification not only encourages the action of the rennet and the synaeresis of the curds, but also inhibits the growth of many undesirable bacteria, certain of which are pathogenic bacteria, and allows their elimination at a greater or lesser speed.

The acidifying activity of this bacterium is accompanied by urea hydrolysis activity, which affects the acidification kinetics. Tinson et al (1982) showed that the urea hydrolysis reaction, which converts urea into carbon dioxide and ammonia, results in a temporary decrease in the acidification speed, as measured by a pH probe.

On an industrial scale, the hydrolysis of urea by Streptococcus thermophilus poses a number of problems. This is because, in cheese manufacturing for example, the technological operations (cutting of the curds, stirring, etc.) must take place at given values of pH, but in practice these operations are generally carried out at predetermined times. Therefore the variations in acidifying activity due to urea hydrolysis lead to defects and significant variability in the texture, moisture level, and ripening properties of the resulting cheeses. Moreover, because ammonia is basic, the production of ammonia increases the time necessary to reach a given pH. This results in the cheese-making equipment being tied up for longer and in an increase of the risk of contamination by undesirable micro-organisms. Furthermore, it is desirable that the cheese-making whey does not contain an excessive amount of ammonia, because this whey is often used as an ingredient in human food and animal feed. The production of ammonia from urea is difficult to control, in part because the urea content of milk is variable (for example, from 2 to 8 mM) and depends in part on the diet of the livestock that produce the milk.

To overcome this problem, Martin et al (1997) proposed measuring the urea content of the milk and then adapting the manufacturing parameters. However, such a system, which requires quantitatively determining the amount of urea, would be highly constraining, and would not resolve the other drawbacks caused by reduction of acidification speed in the presence of urea, such as the equipment being tied up for a longer time, increased risk of contamination, high ammonia content of the whey, etc.

U.S. Pat. No. 6,962,721, which is hereby incorporated by reference in its entirety, describes the use of Streptococcus thermophilus strains lacking the ability, or having reduced ability, to hydrolyze urea, (herein termed S. thermophilus “ur(−) bacteria”) as lactic ferments in the production of dairy products. The inventors have unexpectedly found that many of the above-mentioned problems can be resolved by using ur(−) Streptococcus thermophilus bacteria.

### BRIEF DESCRIPTION OF THE FIGURES

FIG. 1 is a graph with a table insert showing exemplary activity profiles of ur(+) and ur(−) bacteria;

FIG. 2 is a graph showing exemplary activity profiles of ur(+) and ur(−) bacteria; and

FIG. 3 is a photograph showing an exemplary result from a floating curd experiment in test tubes.

### SUMMARY

Methods, compositions, and systems for producing cheese with S. thermophilus and a urease inhibitor, and for producing cottage cheese with S. thermophilus that are partially or completely deficient in their ability to release ammonia from urea are provided. Methods, compositions, and systems for reducing the amount of open texture (e.g., slits, cracks, or fractures) in gassy cheeses, which may include cheeses that produce gas during ripening, such as, for example, cheddar cheese, are also provided.

Various exemplary bacterial strains are occasionally referred to herein. Certain strains are referred to by the nomenclature CNCM followed by letters and/or numbers, or DSM followed by letters and/or numbers. These references are the deposit numbers at the Collection Nationale de Cultures de Microorganismes (CNCM) and the Deutsche Sammlung von Mikroorganismen (DSMZ), respectively. All strains referred to by such numbers have been deposited in the respective culture depositories under the reference numbers referred to herein, as follows: CNCM I-2311 was deposited at the CNCM on 14 Sep. 1999 by Texel/Rhodia services and is described in U.S. Pat. No. 6,962,721 which is hereby incorporated by reference it its entirety; CNCM I-2312 was deposited at the CNCM on 14 Sep. 1999 by Texel/Rhodia services and is described in U.S. Pat. No. 6,962,721 which is hereby incorporated by reference in its entirety; CNCM I-2980 was deposited at the CNCM on 26 Feb. 2003 by Rhodia Food SAS, and is described in WO 04/085607 which is hereby incorporated by reference in its entirety; CNCM I-3617 was deposited at the CNCM on 14 Jun. 2006 in the name of Danisco France SAS and is described in WO 08/040734 which is hereby incorporated by reference in its entirety; DSM 21892 was deposited at the DSMZ on 7 Oct. 2008 in the name of Danisco Deutschland GmbH and is described in WO 10/066907 which is hereby incorporated by reference in its entirety; and DSM 18344 was deposited at the DSMZ on 14 Jun. 2006 and is described in WO 07/144770 which is hereby incorporated by reference in its entirety.

In one aspect, methods for producing cheese, such as cottage cheese, are provided comprising the following steps: a) inoculating milk with ur(−) Streptococcus thermophilus bacteria, wherein the S. thermophilus bacteria are not able to release ammonia from urea, or wherein the S. thermophilus bacteria have a diminished ability to release ammonia from urea compared to wild-type S. thermophilus; b) fermenting the milk with the ur(−) Streptococcus thermophilus bacteria; and c) optionally making further adequate steps resulting in the produced cheese, which in some aspects is cottage cheese. See, e.g., methods of making cottage cheese in U.S. Pat. Nos. 6,482,460; 6,238,717; 3,298,836; WO91/00690; and U.S. Pat. No. 3,968,256; all of which are hereby incorporated by reference in their entirety.

In certain aspects, the milk is cow's milk, goat's milk, sheep's milk, or any other type of suitable milk. In particular aspects, the milk is inoculated with 10⁴ to 10¹³ cfu/ml of S. thermophilus ur(−), or with 10⁸ to 10¹² cfu/ml of S. thermophilus ur(−) bacteria. In certain aspects, the fermentation time in step b) is from 3 to 7 hours (e.g., 3 hours . . . 4.2 hours . . . 5.5 hours . . . 6.1 hours . . . or 7 hours)

In other aspects, the milk is also inoculated with Lactococcus bacteria, such as Lactococcus lactis or Lactococcus cremoris bacteria. In further aspects, the Lactococcus bacteria are homofermentative Lactococcus bacteria. In certain aspects, the milk is inoculated with 10⁴ to 10¹³ cfu/ml of Lactococcus bacteria or 10⁸ to 10¹² cfu/ml of Lactococcus bacteria

In particular aspects, the further adequate steps referred in step c) can include, without limitation: i) when pH has reached around 4.65, the coagulum is cut into cheese curd in order to separate the whey from the cheese curd; and ii) scalding (heating) (e.g., in order to stop the bacterial fermentation process), is performed, for example, in a cheese vat at the surface of the whey by a steam-injector inserted right below the whey surface and above the cheese curd. In certain aspects, additional adequate steps, for example steps that are known in the cheese-making or food-processing arts, may be included in step c). In some aspects, no further adequate steps will be required.

Combinations of Lactococci and S. thermophilus may be used in cottage cheese production. This combination may increase the cheese yield. However, the combination may cause cheese curd to float to the top in the vat. The floating curd may make processing the vat difficult. Without wishing to be bound by theory, the floating curd problem is believed to be due to the urease activity associated with ur(+) S. thermophilus, which are able to release ammonia from urea. Therefore in certain aspects, Streptococcus thermophilus bacteria which are not able (partially or preferably totally) to release ammonia from urea (i.e. the ur(−) S. thermophilus) are used in a process for producing cottage cheese. The floating cheese curd problem may be resolved or mitigated by using such ur(−) bacteria. In some aspects ur(−) Streptococcus thermophilus bacteria are used in combination with Lactococcus bacteria in a process for producing cottage cheese.

In particular aspects, the ur(−) Streptococcus thermophilus strains are the strains described in U.S. Pat. No. 6,962,721. In some aspects, the Streptococcus thermophilus strains are selected from the group consisting of 298-K (CNCM 1-2311), 298-10 (CNCM 1-2312), and any mutant thereof. In particular aspects, ur(−) Streptococcus thermophilus strains are selected from the group consisting of CNCM 1-2311, CNCM 1-2312, CHCC9908, and mutants of any of these.

In some aspects, the cottage cheese product produced by the methods described herein is provided.

Particular aspects provide the use of a Streptococcus thermophilus ur(−) mutant of a strain selected from the group consisting of: CNCM I-2980, DSM21892, CNCM I-3617, CNCM I-3617, CHCC4325, DSM18344, and DSM18111, in a process for producing cottage cheese.

Particular aspects provide methods for producing a dairy product such as cheese (e.g., cottage cheese, cheddar cheese, mozzarella, pizza cheese, blue cheese, Swiss cheese, or any other type of cheese) or yogurt comprising: a) inoculating milk with Streptococcus thermophilus bacteria and a urease inhibitor; and b) fermenting the milk with the bacteria under conditions such that the dairy product (e.g., cheese or yogurt) is produced. In particular aspects, the cheese is cottage cheese.

In some aspects, the Streptococcus thermophilus bacteria are able to release ammonia from urea (e.g., strains CNCM I-2980, DSM21892, CNCM I-3617, CHCC4325, and DSM18344). In certain aspects, the Streptococcus thermophilus bacteria are not able to release ammonia from urea or have a diminished capacity to release ammonia from urea compared to wild-type S. thermophilus (e.g., 10% less than wild-type . . . 50% less than wild-type . . . 90% less than wild-type), e.g. CNCM 1-2311, CNCM 1-2312, CHCC9908. In some aspects, the Streptococcus thermophilus bacteria are a mixture of Streptococcus thermophilus bacteria able to release ammonia from urea and Streptococcus thermophilus bacteria not able to release ammonia from urea or having a diminished capacity to release the same amount of ammonia from urea that is released by wild-type S. thermophilus.

In particular aspects, the urease inhibitor comprises flurofamide. In other aspects, the urease inhibitor comprises a diphenol, a quinone, a hydroxamic acid, a thiol, or a phosphoramide. In particular aspects, the urease inhibitor comprises agrotain or acetohydroxamic acid. In other aspects, the urease inhibitor comprises a combination of more than one of the above-mentioned urease inhibitors.

In some aspects, systems and compositions comprising: milk, Streptococcus thermophilus bacteria, and aurease inhibitor are provided. In further aspects, systems and compositions comprising: milk, Streptococcus thermophilus bacteria, Lactococcus bacteria and a urease inhibitor are provided.

In yet another aspect, systems and compositions comprising cheese and a urease inhibitor are provided.

In certain aspects, methods of producing reduced-texture cheese comprising: a) inoculating milk with: i) urease positive Streptococcus thermophilus bacteria and a urease inhibitor, and/or ii) urease negative Streptococcus thermophilus bacteria, which are not able to release ammonia from urea at same level as wild-type bacteria; and b) fermenting the milk under conditions such that initial cheese is produced; and c) aging the initial cheese for a period of time such that reduced-texture cheese is produced which has a reduced amount of open-texture compared to control cheese, wherein the control cheese is produced in the same manner as the open-texture cheese but employs the urease positive Streptococcus thermophilus bacteria without the urease inhibitor are provided.

In some aspects, the period of time for the aging is at least 1 month (e.g., at least 1 month . . . 2 months . . . 3.5 months . . . 5 months . . . 6 months . . . 12 months . . . 2 years . . . or longer). In other aspects, the reduced-texture cheese is a gassy cheese. In some aspects, the reduced-texture cheese is a hard and semi hard cheese, for. example Cheddar, Red Leicester, American cheese, gouda, edam, emmental, an Italian cheese like Parmesan, Parmigiano, Regiano, Grana Padano, Provolone, Pecorino, Romano. In further aspects, the reduced-texture cheese is cheddar cheese. The expression “open-texture” includes slits, cracks, eyes, holes, fractures, and combinations thereof. In particular aspects, the reduced-texture cheese contains no, or essentially no, visible slits, cracks, fractures and the like. In other aspects, the reduced-texture cheese contains at least 10% less open texture than said control cheese after period of time (e.g., at least 10% . . . 25% . . . 40% . . . 65% . . . 75% . . . 85% . . . 95% . . . or 99% less open texture than the control cheese after a period of time, such as 1 month . . . 6 months . . . 2 years . . . etc).

In other aspects, compositions comprising a cheese selected from the group consisting of: cheddar, Red Leicester, American cheese, gouda, edam, emmental, an Italian cheese like Parmesan, Parmigiano, Regiano, Grana Padano, Provolone, Pecorino, and Romana, and a urease inhibitor are provided. In additional aspects, the cheddar cheese contains no, or essentially no, visible slits, cracks, fractures and the like.

### DETAILED DESCRIPTION

Methods, compositions, and systems for producing cheese with S. thermophilus and a urease inhibitor, and for producing cottage cheese with S. thermophilus that is partially or completely deficient in its ability to release ammonia from urea are provided. Methods, compositions, and systems for reducing the amount of open texture (e.g., slits, cracks, fractures, eyes, holes, or combinations thereof) in gassy cheeses, which may include cheeses that produce gas (such as carbon dioxide) during ripening, such as, for example, cheddar cheese, are also provided.

One of the problems with the use of S. thermophilus for making cottage cheese is that the cheese curds float to the top of the vat, which is undesirable. Due to the floating curds, the cheese is very difficult to process the vat. Without wishing to be bound by theory, it is believed that the floating cheese curd problem in cottage cheese production is due to urease activity associated with S. thermophilus. As such, in some aspects, methods and compositions for making cottage cheese that employ a urease inhibitor and/or S. thermophilus bacteria that do not produce active urease enzymes, or that produce a lower quantity of urease enzymes than wild-type S. thermophilus bacteria, or that produce urease enzymes that have less activity than those produced by wild-type S. thermophilus bacteria, are provided.

Without wishing to be bound by theory, it is believed that S. thermophilus ur(+) bacteria are responsible for open-texture such as slits, eyes, cracks, holes, fractures or combinations thereof. The urease produced by S. thermophilus ur(+) bacteria is believed to hydrolyze urea into carbon dioxide and ammonium. At the relevant temperatures, carbon dioxide is a gas.

The carbon dioxide released by urease enzymes is also believed to be a cause of the floating curd problem. The inventors have recognized that, when S. thermophilus ur(+) bacteria are used, the presence of floating curd depends on the urea levels of the milk that is used. Also, the amount of floating curd (measured in curd height), may be from about 10 cm to about 20 cm when S. thermophilus ur(+) bacteria are used. What is more, the levels of floating curd increase when the temperature is increased, such as during a cooking step. This observation is consistent with the presence of carbon dioxide gas trapped in the curd. The volume of carbon dioxide trapped in the curd increases with increasing temperature. As the volume of trapped carbon dioxide increases, the buoyancy of the curd also increases. As the curd becomes more buoyant, more curd will float.

When S. thermophilus ur(−) bacteria are used, however, the amount of floating curd is reduced or eliminated. Without wishing to be bound by theory, the absence of urease enzymes is believed to correspond to an absence of produced carbon dioxide because urea is not hydrolyzed into ammonium and carbon dioxide. Without the production of carbon dioxide by bacteria, the curd does not become buoyant, reducing or eliminating float.

U.S. Pat. No. 6,962,721 discloses a S. thermophilus that is partially or completely deficient in its ability to release ammonia from urea. This patent also explains how to make such S. thermophilus ur(−) bacteria. A person of ordinary skill in the art also knows how to identify whether a particular S. thermophilus strain is a ur(−) strain. For example, a suitable plate assay to test for urease activity is provided in Example 1 of U.S. Pat. No. 6,962,721, which is hereby incorporated by reference in its entirety.

In one aspect, methods of using urease inhibitors with S. thermophilus (for example, a wild-type S. thermophilus that is able to make active urease) to make any type of cheese are provided. Exemplary cheeses include, but are not limited to, American cheese, Bergenost, Brick cheese, Cottage cheese, Colby cheese, Colby-Jack cheese, Cream cheese, Cup Cheese, Farmer cheese, Liederkranz cheese, Maytag (Blue cheese), Monterey Jack, Muenster cheese, Pepper jack cheese, Pinconning cheese, Provel cheese, String cheese, Swiss cheese, Teleme cheese, Camembert, Brie de Meaux, Roquefort, Boursin, Reblochon, Munster, Pont l'Evêque, Époisses, Chèvre, and Tomme de Savoie.

The amount of the urease inhibitor required per vat during manufacturing can be calculated, for example, using the TOCRIS BIOSCIENCE molarity triangle. Alternatively or in addition, empirical methods can be used to determine the optimized amount to use. In particular aspects, any appropriate amount of urease inhibitor may be used. In certain aspects, appropriate amounts of urease inhibitor are amounts that yield cheese having the desired texture, moisture level, ripening properties, or a combination thereof.

Methods, compositions, and systems for reducing the amount of open texture (for example, slits, cracks, holes, fractures, and the like) in gassy cheeses, which may include cheeses that produce gas (such as carbon dioxide) during ripening, such as, for example, cheddar cheese, are provided. It is contemplated that the urease activity of Streptococcus thermophilus strains is responsible for the open texture (such as cracks, slits, holes, and the like) in gassy cheese such as cheddar. Using Streptococcus thermophilus ur(−), Streptococcus thermophilus ur(+)with an urease inhibitor, or a combination thereof, may, in some aspects, prevent unwanted open texture.

Without wishing to be bound by theory, it is believed that during production of a gassy cheese (for example, hard cheese, semi hard cheese, and the like), such as cheddar, using Lactococci and Streptococcus thermophilus, urea is trapped in the cheese curd. As such, during storage the urea is slowly metabolized by Streptococcus thermophilus urease to ammonia and CO₂. If the CO₂ cannot escape, it may result in unwanted open texture, such as cracks, splits, fractures, and the like, that may be observable, for example, by visual inspection of the cheese. Such formation of open texture may occur after about 3-4 months. In some cases, for example where the ripening temperature is increased to 12° C., the open texture is visible. Without wishing to be bound by theory, it is believed that the urease is more active at elevated temperatures, but has lower activity at standard ripening temperatures, which in some aspects is 4° C. Additional compositions and ripening conditions according to the aspects described herein will be apparent to those skilled in the art without departing from the scope and spirit of the description herein, which is intended to encompass at least the full scope of the appended claims.

In certain aspects, the amount of time to reach a desired pH using certain ur(−) S. thermophilus bacteria can be decreased, for example, by adding Lactococci bacteria to the milk used in the fermentation process. In particular aspects, the amount of time to reach a desired pH can be decreased by adding formate, for example, sodium formate.

In some aspects a formate, for example sodium formate, is used with S. thermophilus ur(−) or ur(+) bacteria. In other aspects, an ammonium source, for example ammonium phosphate, is used with S. thermophilus ur(−) or ur(+) bacteria. In particular aspects, both a formate source and an ammonium source are used with S. thermophilus ur(−) or ur(+) bacteria.

Furthermore; the inventors have shown that a mixture of Streptococcus thermophilus ur(−) bacteria with formate and Lactococci bacteria is just as active as a mixture of Streptococcus thermophilus ur(+) bacteria with formate and Lactococci bacteria. Without wishing to be bound by theory, it is believed that Lactococci bacteria generate other nitrogen containing nutrients that are usable by the Streptococcus thermophilus ur(−) bacteria. These nutrients are believed to be peptides or amino-acids, which are generated by protease enzymes in Lactococci.

### EXAMPLE 1

Samples of fresh 1% milk were treated with various combinations of S. thermophilus bacteria and Lactococci bacteria as shown in Table 1. In each experiment, an acidification curve was determined by measuring the pH of the milk from the time of addition until 250 minutes after addition. Milk from one source was used as the starting material for each experiment. The temperature of the milk was held at 35° C. for the duration of each experiment. The activity of the S. thermophilus bacteria was correlated to the amount of time that it takes for the pH of the milk to reach a particular level.

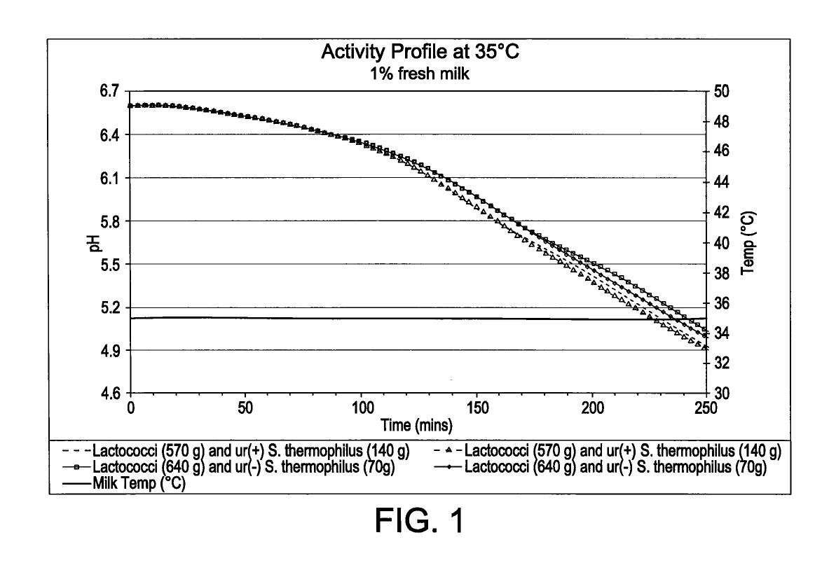

Table 1 and FIG. 1 show exemplary results of four experiments. Mixtures of Lactococci bacteria, formate and either ur(+) or ur(−) S. thermophilus bacteria were added to 1% milk, as shown in Table 1. An exemplary acidity profile was determined, and is depicted in FIG. 1. Table 1 also shows selected exemplary data from the acidity profile of FIG. 1.

TABLE 1

| | Urease | | | | | |
|---|---|---|---|---|---|---|
| | activity of the | | | | V6-5 | |
| | S. thermophilus | | | | (pH/min | |
| | strain | Ta | T5.20 | M6-5 | 10\hat{ }4) | T4.64 |
| Lactococci (570 g), S. | Ur(+) | 54.96818 | 221.9714 | −0.00962 | −9.62 | 293.2863 |
| thermophilus (140 g) | Ur(−) | 53.4535 | 218.2618 | −0.010105 | −10.105 | 294.7521 |
| and sodium formate | | | | | | |
| (10 ppm)) | | | | | | |
| Lactococci (640 g), S. | Ur(+) | 52.395 | 233.6455 | −0.009025 | −9.025 | 311.678 |
| thermophilus (70 g) and | Ur(−) | 54.347805 | 227.5821 | −0.00979 | −9.79 | 306.3275 |
| sodium formate (10 ppm) | | | | | | |

FIG. 1 and Table 1 show that when 70 g S. thermophilus is used instead of 140 mg S. thermophilus, the milk takes a longer time to reach pH 5.2 (T5.2) and pH 4.65 (T4.65). Nonetheless, the slope of the line from pH 6 to pH 5 (M6-5) and the “velocity” of S. thermophilus action in pH units per minute between pH 6 and pH 5 (V6-5) is identical (within the experimental error) for all four experiments. Further, for experiments using the same amount of S. thermophilus there are no significant differences in the acidification curves when ur(−) S. thermophilus is used in place of ur(+) S. thermophilus. Thus, the exemplary results in FIG. 1 demonstrate that ur(−) S. thermophilus with Lactoccocci and formate act just as rapidly as ur(+) S. thermophilus with Lactoccocci and formate.

Thus, one aspect relates to increasing the rate of action of a ur(−) S. thermophilus bacteria on milk by adding a Lactoccocci bacteria to the milk with the S. thermophilus bacteria.

### EXAMPLE 2

Samples of 2% milk taken from the same source were treated with ur(+) S. thermophilus without formate, ur(−) S. thermophilus without formate, and ur(−) S. thermophilus with 10 ppm sodium formate. Lactoccocci bacteria were not used. The milk was maintained at 40° C., and pH measurements were taken for 350 minutes.

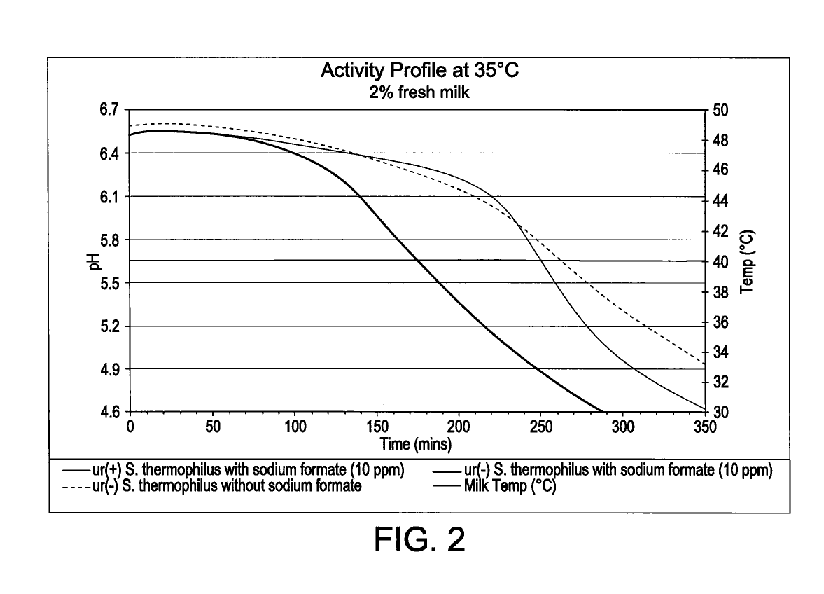

FIG. 2 is a graph showing exemplary results from this experiment. Upon addition of 10 ppm sodium formate, any pH decrease effected by the ur(−) S. thermophilus is significantly accelerated.

Thus, in one particular aspect, the rate of action of S. thermophilus, such as ur(−) or ur(+) S. thermophilus bacteria, on milk by adding formic acid or a formate, such as sodium formate, is increased.

Without wishing to be bound by theory, it is believed that the enzyme pyruvate formate lyase, present in S. thermophilus, is anaerobic and has little or no activity in the presence of oxygen. When it is active, pyruvate formate lyase is believed to produce formate. When oxygen is present, S. thermophilus activity is believed to decrease because the amount of formate produced by pyruvate formate lyase is reduced. When an external formate source, such as sodium formate, is added, the activity of S. thermophilus is increased. Formate sources other than sodium formate may also be used for this purpose.

### EXAMPLE 3

Four experiments were conducted in which milk was treated with various bacteria. In experiment 1, only Lactococci bacteria were added. In experiment 2, a blend of Lactococci bacteria and ur(+) S. thermophilus bacteria were added. In experiment 3, a blend of Lactococci bacteria, ur(+) S. thermophilus bacteria, and the urease inhibitor flurofamide were added. In experiment 4, only ur(+) S. thermophilus bacteria were added.

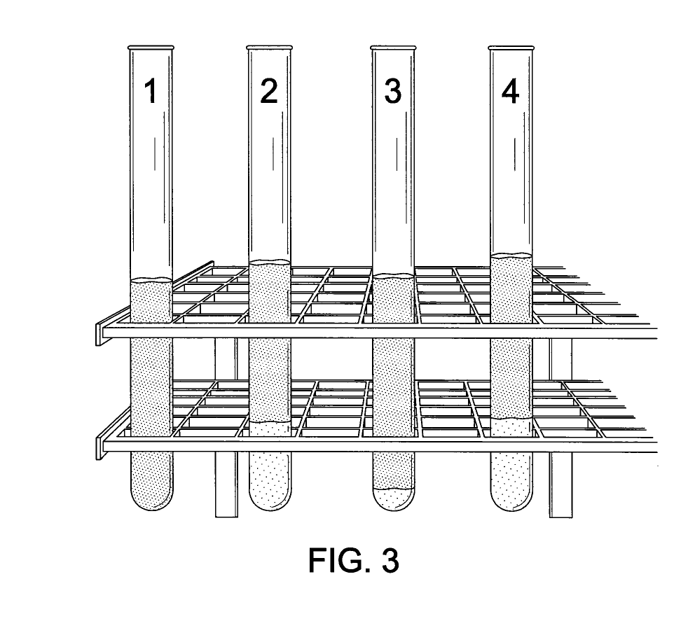

In each experiment, the milk was fermented with the bacteria at 35° C. until the cheese reached a pH of 4.65. A sample of the cheese was placed into a test tube, which was heated at about 66° C. for about 10 minutes. After 10 minutes of heating, a small pipette or thin wire was used to agitate the sample. The samples were held at about 66° C. for another ten minutes, at which time the photograph of the test tubes depicted in FIG. 3, was taken.

FIG. 3 shows that there is no floating curd in test tubes 1 and 3, which correspond to experiments 1 and 3, respectively. Test tubes 2 and 4, which correspond to experiments 2 and 4, respectively, contain floating curd. These results are consistent with the notion that floating curd results from the action of urease enzymes. Test tube 1 is a negative control that contains only Lactococci, shows no floating curd because Lactococci do not contain urease enzymes that can hydrolyze urea in milk. Test tube 4 is a positive control that contains ur(+) S. thermophilus, which has urease enzymes that can hydrolyze urea in milk. Test tube 2, which contains floating curd, and test tube 3, which does not, both contain a mixture of Lactococci and S. thermophilus. These test tubes differ only in that test tube 3, which does not contain floating curd, was made in the presence of a urease inhibitor that inactivates the urease enzyme and prevents it from hydrolyzing urea to carbon dioxide and ammonia. Thus, test tubes 2 and 4, which include an active urease enzyme, exhibit floating curd, whereas test tubes 1 and 4, which either have no urease enzyme (test tube 1) or have a urease enzyme that is deactivated by an inhibitor (test tube 4) do not contain floating curd.

In some aspects, floating curd can be correlated to the presence of active urease enzymes. In particular aspects, a urease inhibitor may be added to ur(+) bacteria, such as ur(+) S. thermophilus, in order to reduce the amount of floating curd relative to the amount that is present without the urease inhibitor. In certain aspects, the urease inhibitor results in no floating curd. In specific aspects, the amount of floating curd is reduced, relative to the amount that is produced when ur(+) S. thermophilus bacteria is used, by using ur(−) S. thermophilus bacteria. In some aspects, the use of ur(−) S. thermophilus bacteria results in no floating curd.

Although the description herein is in connection with specific preferred aspects, it should be understood that the claims should not be unduly limited to such specific aspects. For example, while particular strains of S. thermophilus ur(−) bacteria and particular types of milk and cheese are used to illustrate the basic principles described herein and means for practicing the associated methods, the artisan would readily understand that the same results could be obtained with other strains of S. thermophilus ur(−) bacteria, could be applied to other types of milk, and could be used to make other types of cheese. Indeed, various modifications of the described modes for carrying out the aspects described herein that are obvious to those skilled in the relevant fields are intended to be within the scope of the following claims.

1-13. (canceled)

14. A method for producing cottage cheese comprising following steps:
a) inoculating milk with Streptococcus thermophilus bacteria, characterized by that the S. thermophilus bacteria are not able to release ammonia from urea (herein termed S. thermophilus “ur(−) bacteria”);
b) fermenting the milk with the bacteria; and
c) optionally making further adequate steps to finally end up with the produced cottage cheese.

15. The method of claim 14, wherein the milk in step (a) is cow milk.

16. The method of claim 14, wherein there in step (a) is inoculated from 10<4> to 10<13> cfu/ml of S. thermophilus ur(−) bacteria to the milk, more preferably there is inoculated from 10<8> to 10<12> cfu/ml of S. thermophilus ur(−) bacteria to the milk.

17. The method of claim 14, wherein the fermentation time in step b) is from 3 to 7 hours.

18. The method of claim 14, wherein the milk in step a) is also inoculated with Lactococcus bacteria, preferably Lactococcus lactis bacteria.

19. The method of claim 18, wherein Lactococcus bacteria are homofermentative Lactococcus bacteria.

20. The method of claim 18, wherein there in step a) is inoculated from 10<4> to 10<13> Q cfu ml of Lactococcus bacteria to the milk, more preferably there is inoculated from 10 to 10<12> cfu/ml of Lactococcus bacteria to the milk.

21. The method of claim 14, wherein the further adequate steps of step c) include following steps:
i) when pH has reached around 4.65, the coagulum is cut into cheese curd in order to separate the whey from the cheese curd; and
ii) scalding (heating), done in order to stop the bacteria fermentation process, done in the cheese vat at the surface of the whey by a steam-injector lowered down right below the whey surface and above the cheese curd.

22. Use of Streptococcus thermophilus bacteria which are not able to release ammonia from urea (herein termed S. thermophilus “ur(−) bacteria”) in a process for producing cottage cheese.

23. Use of Streptococcus thermophilus bacteria strains selected from the group consisting of: 298-K (CNCM 1-2311), 298-10 (CNCM 1-2312), CHCC9908, and mutants of any of these, in a process for producing cottage cheese.

24. Use of a Streptococcus thermophilus ur(−) mutant of a strain selected from the group consisting of: CNCM 1-2980, DSM21892, CNCM 1-3617, CNCM 1-3617, CHCC4325, DSM18344, and DSM18111, in a process for producing cottage cheese.

25. A Streptococcus thermophilus ur(−) mutant of a strain selected from the group consisting of: CNCM 1-2980, DSM21892, CNCM 1-3617, DSM18344, and DSM18111.

26. Cottage cheese obtained by the method of claim 14.
